(19) United States
(12) Patent Application Publication
(10) Pub. No.: US 2008/0168274 A1
(43) Pub. Date: Jul. 10, 2008

(54) System And Method For Selectively Enabling Features On A Media Device

(76) Inventors: Victor Natanzon, Manalapan, NJ (US); Ralph Harvey, Ft. Lauderdale, FL (US)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/759,453

(22) Filed: Jun. 7, 2007

Related U.S. Application Data
(60) Provisional application No. 60/883,520, filed on Jan. 5, 2007.

(51) Int. Cl. H04L 9/00

(52) U.S. Cl. 713/175

(57) ABSTRACT

A system and method for selectively enabling a feature of a controlled device. At least one feature on a controlled device is initially disabled. Content including a test is downloaded from a server to a mobile device. A user inputs into the mobile device background information and answers to the test. A score is generated based on the answers. If the score is high enough, a certificate is generated including release codes. The certificate is sent to the mobile device. The user may then place the mobile device in communication with the controlled device so as to forward the release codes and thereby enable the feature.

This application claims priority to provisional application 60/883,520 filed Jan. 5, 2007 entitled “MOBILE EDUCATION CONTROL DEVICE”, the entirety of which is hereby incorporated by reference.

### BACKGROUND OF THE INVENTION

It is sometimes desirable to restrict access to certain features of entertainment and communication devices. Such restriction is useful in, for example, the area of children's education where it is frequently not possible to monitor whether a child has genuinely completed an educational work task. Children's education, and other educational areas, would benefit from a system which can monitor whether a student or user has completed a particular educational task, and only after confirmation that the task has been completed, allow access to a particular entertainment or communication device. However, there is no such system available in the art.

### SUMMARY OF THE INVENTION

One embodiment of the invention is a method for enabling a feature of a controlled device. The method comprises disabling at least one feature of a controlled device; forwarding a test to a user; and receiving at least one answer to the test from the user. The method further comprises determining a score based on the answer; generating a certificate based on the score; forwarding the certificate to the user; and enabling the at least one feature of the controlled device based on the certificate.

Another embodiment of the invention is a system for enabling a feature of a controlled device. The system comprises a first device effective to receive a test, display the test to a user, and to receive at least one answer from the user relating to the test. The system further comprises a processor in communication with the first device, the processor effective to generate a certificate based on the answer; wherein the first device is further effective to receive the certificate and communicate the certificate to a controlled device; and wherein a feature of the controlled device is enabled based on the certificate.

### BRIEF DESCRIPTION OF THE DRAWINGS

FIG. 1 is a system diagram illustrating a system which could be used in accordance with an embodiment of the invention.

FIG. 2 is a diagram representing fields in a database which may be used in accordance with an embodiment of the invention.

FIG. 3 is a diagram representing possible contents of a database in accordance with an embodiment of the invention.

FIG. 4 is a flow diagram illustrating a process which could be used in accordance with an embodiment of the invention.

### DETAILED DESCRIPTION OF THE PREFERRED EMBODIMENT(S)

A system in accordance with an embodiment of the invention disables at least some features on an entertainment or media or multimedia device or devices such as a PC, Television or video game system until defined preconditions are met.

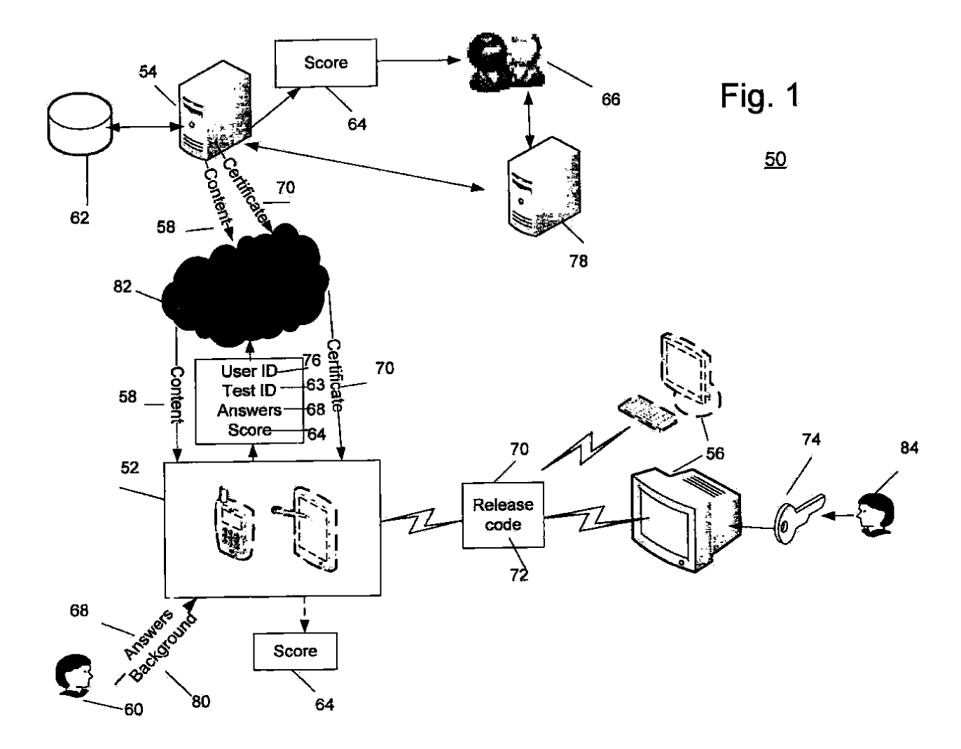

Referring to FIG. 1, there is shown a system 50 in accordance with an embodiment of the invention. System 50 includes a controlling device 52 effective to receive content 58 forwarded from a processor or server 54. System 50 further includes a controlled device 56. Controlling device 52 may be a computer or a mobile device such as a cell phone, PDA, etc. or may be a device specially designed to receive and run content 58.

For example, controlling device 52 may be a smart phone or PDA which may run a C, C++, or JAVA application. Content 58 may include an embedded security tag that may be generated dynamically upon a registration by a user 60 accessing content 58. For a phone, the tag may be mapped to the user's phone number. The tag ensures that content 58 may run only on registered devices. The tag may be validated against the SIM (subscriber identify module) of the phone or MAC (media access control) address or other unique identifier of a computer.

Controlled device 56 may be any media device such as a television, video game system, computer, etc. Certain features of controlled device 56 are initially disabled until a user inputs a release code as is discussed below. The features may be disabled by simply having someone restrict the features for device 56 such as through an interface like a web interface. For example, all features except emergency features of a phone may be disabled. For a television or other commercially available device, a suitable interface may be added to allow for the disabling of certain features. For example, an interface utilizing BLUETOOTH or other infrared gateway may be used to enable lock codes available on certain televisions such as parental controls. For a computer, software may be used to disable an application so that a request to run the application is intercepted and compared against an allowable list of applications before run. For example, a search engine may be disabled so as to only run in a safe mode until a test has been passed. For a mobile phone, text messaging, music applications, and most numbers may be disabled until a test is passed.

Content 58 may be sent to device 52 through any known methods including wireless transmission using a cellular network, internet enabled transmission using one of the TCP/IP protocols through a network 82, WI-FI communication, or any other known method.

User 60 may be prompted to input certain background information 80 that may be used to more completely evaluate the user, and answers input by user, as is discussed in more detail below. Alternatively, background information 80 may be entered by user 60 after the user has accessed content 58. Content 58 may include educational materials such as a test. A test may include a set of multiple choice questions that may require multiple selections or a set of check boxes, text input fields and/or text areas that require entry. The test may in the form of flash cards where the user is effectively asked a single question at a time. These question styles may further be combined to create composite question styles on the mobile device.

A user 60 using device 52 may access content 58 on device 52 such as by, for example, taking a test included in content 58 and inputting answers 68. The test may be presented visually or audibly through the use of a Text to Speech (TTL) engine. Answers may also be input by using Interactive Voice Recognition. When the test is completed, the test is scored either by device 52, using a scoring algorithm forwarded with content 58, or the answers are sent to server 54 along with a user identifier 76 and scored by server 54. After a score 64 is generated, score 64 may be stored in a database 62 in communication with server 54 along with user identifier 76 identifying user 60 and an identifier 63 identifying the test.

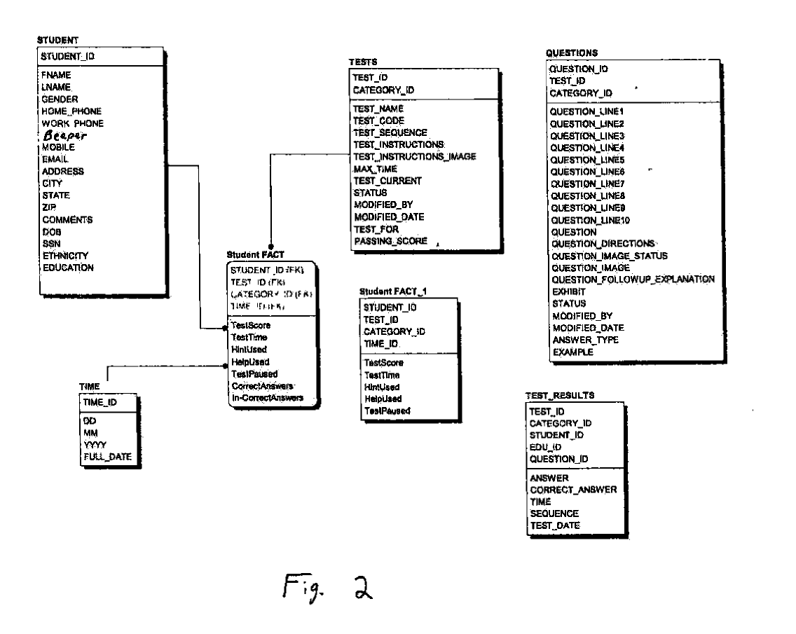

An example of the fields which may appear in database 62 is shown in FIG. 2—though clearly other fields may be used. As illustrated, information about the student or user may include: the student's identifier, first name, last name, gender, home phone number, work phone number, beeper number, mobile phone number, email address, postal address, city, state, zip code, any comments, date of birth, social security number, ethnicity and education.

Information about tests may include: a test identifier, a category identifier describing the type of test, the test name, test code, test sequence, test instructions, an image of the test instructions, maximum time to take the test, test current, status of the test, who modified the test, the modified date, what the test is for, and a passing score.

For questions on the test, database 62 may store: a question identifier, a test identifier, a category identifier, a list of the questions, question directions, an image of the question status, an image of the questions, follow up explanations, an exhibit to the questions, a status of the questions, who modified the questions, when the questions were modified, answer type, and an example.

Student facts may be stored including the student's identifier, test identifier, category identifier, time identifier, test score, time used to take test, any hint used, any help used, if the test was paused, the correct answers and incorrect answers. For time, the day, month and year may be stored. For test results, database 62 may store: the test identifier, category identifier, student identifier, education identifier, question identifier, the student's answer, correct answer, time, sequence of questions, and test date.

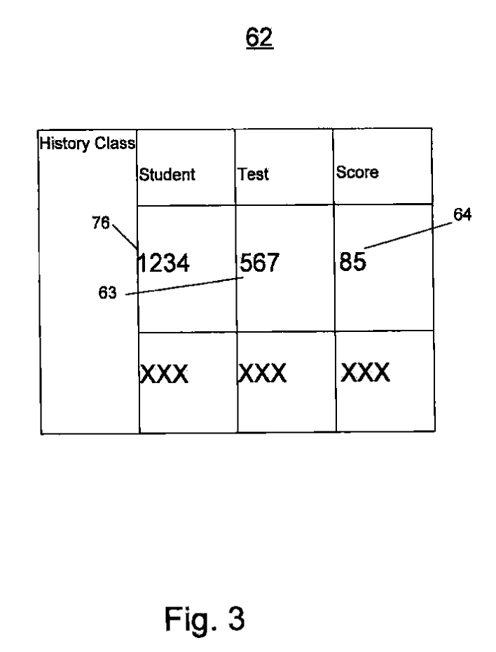

A simplified version of database 62 is show at FIG. 3. Database 62 may indicate that a user with user ID (76) of 1234 received a score (64) of 85 on the test with an identifier (63) of 567. In this way, with simple calculations, a cumulative average of tests and scores of user 60 may be maintained in database 62. Moreover, a comparison of the user's scores to other student's scores for a particular test may be generated, stored in database 62 and displayed to the user on, for example, device 52. Score 64 may also be communicated to a test authority 66 including a recipient list of teachers, instructors or other relevant body. Communication to test authority 66 may be through server 54 or through email, Internet or any other form of communication. Testing authority 66 may also communicate with database 62 directly.

After score 64 is generated, server 54 compares score 64 with a passing score for the particular test in content 58. If score 64 is equal to or greater than the passing score, a certificate 70 is produced. Certificate 70 may include information related to the test in content 58 including test identifier 63, score 64, an expiration date, time, user ID 76 and controlled device release codes 72, along with a list of applications which can use release codes 72. For example, different codes may be used to control different controlled devices such as a PC, mobile device, video game console, etc. Each one of these controlled devices may have different features each of which may be selectively enabled. For example, access to telephone numbers, certain applications, internet access, etc. may all be selectively enabled.

A notification may be generated on device 52 notifying user 60 of the issuance of certificate 70 or, alternatively, that user 60 did not satisfactorily complete the relevant test. User 60 will see that he now has access to controlled device release codes 72 and may enable features on controlled device 56.

User 60 may then place device 52 in communication with controlled device 56 so that release codes 72 are communicated to controlled device 56. For example, device 52 may be able to communicate wirelessly such as through infra-red waves, BLUETOOTH enabled communication, ZIGBEE protocol, etc., so that simply pointing controlling device 52 toward controlled device 56 may be sufficient to enable communication between the two devices. Features of controlled device 56 may be thereby enabled in accordance with terms of certificate 70. Additional criteria may affect whether features of controlled device 56 are enabled including a time when user 60 attempts to access controlled device 56 (e.g., no enabling after 10 p.m.), a period of time since user 60 last attempted to access controlled device 56, a total amount of time that user 60 has used device 56, etc. Information relating to such criteria may be stored on device 52, device 56, or server 54. The information may affect whether release codes 72 are issued, may be stored in release codes 72, or may be included in certificate 70. Controlled device 56 may read codes 72 using a model schema language (MSL) application.

For example, depending on score 64, release codes 72 may enable only some of the functionality available on controlled device 56—e.g. a higher score enables more functions. Alternatively, release codes may only be able to enable certain functions of device 56 regardless of score 64. The extent that release codes 72 control the operation of controlled device 56 may be affected by testing authority 66 or a parent 76. This is because testing authority 66 or parent 76 may define what applications are enabled, for how long and under what conditions. For example, testing authority 66 may decide that no video games are allowed until a score of 50 is achieved, or until a test has been run a certain number of times. Such restrictions may be entered by testing authority 66 or parent 76 through a web interface and may be transferred with content 58 or on demand via XMPP (extensible messaging and presence protocol).

Controlled device 56 may also be enabled and returned to full functionality by an authority with sufficient credentials via a key 74. For example, a parent 84 may be provided with key 74 so that the parent may access the full functionality of device 56 at any desired time. Key 74 may be a physical key or a password. Release codes 72 may be designed so as to have an expiry condition, such as a time limitation. Once that time limitation passes (for example, 2 hours), controlled device 56 returns to its prior state with certain features disabled.

If user 60 requests to run an application or to operate a specific function of controlled device 56, and user 60 does NOT meet the policy conditions that have been defined (e.g., the user has not satisfactorily completed a test so as to generate a certificate) operation of that function is denied because the function remains disabled. As discussed, the policy conditions may be related to elapsed time, test execution, minimum test result, or time of day.

In this way, an embodiment of the invention allows the end user to engage in tests or quizzes with a goal to enable features on a desired entertainment or communications device.

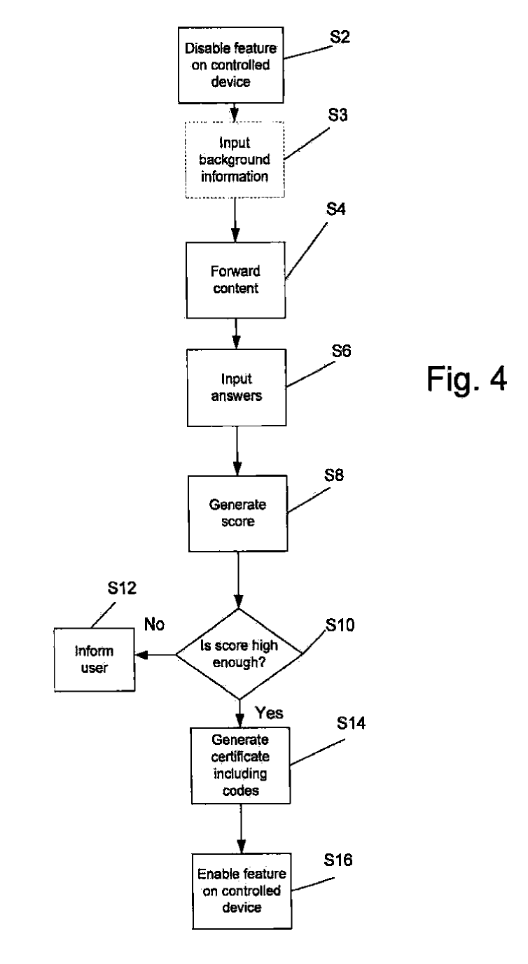

Referring to FIG. 4, there is shown a flow diagram illustrating a process which could be performed in accordance with an embodiment of the invention. The process of FIG. 4 could be implemented using, for example, system 50 of FIG. 1. At step S2, at least one feature on a controlled device is disabled so that access to that feature is limited or inhibited. At optional step S3, a user inputs background information. This step enables a system using the process to produce more intelligent analysis of the user's test scores. At step S4, content (such as a test) is forwarded to a controlling device such as by downloading over a network. At step S6, a user inputs answers to questions included in the content. At step S8, a score is generated based on the questions answered by the user. At step S10, a query is made to determine if the score is above a certain threshold. If the score is below the threshold, at step S12, the user is informed that he did not pass the test and will not receive an enabling release code for a controlled device. If the score is above the threshold, at step S14, a certificate is sent to the user including an applicable release code. At step S16, if the user desires, the user can use the release code to enable a feature on a controlled device. The release code may be limited by time and by user as is discussed above.

The policies and preconditions stored on both the controlled device 56 and controlling device 52 may be described using a meta-language such as XML. In the context of a test running on a mobile phone device, an example of XML code which may used to implement a system in accordance with the invention may be as follows:

```
  <?xml version=“1.0” encoding=“utf-8” ?>
  <mobizamtest>
  <header>
  <descriptiyon>The name of the test</description>
  <testid>The unique identifier for this test</testid>
  <testauthority>authorityname</testauthority>
  <authoritycontact>authority email, sms, web service, or url>
  <contacttype>sms,email,webservice or url>
  <hints value=”yes></hints>
  <help value=”yes”></help>
  <timelimit>300</timelimit>
  <datelimit>expirydate</datelimit>
  </header>
  <questions>
  <question id=“the questioned for this test” select=“single” nextid=“2” title=“the title of
the question” comment=“Please select the single best answer” type=”mc”>
  <case name=“A” image=”image name”>an answer choice for option A</case>
  <case name=“B” image=”image name”>an answer choice for option B</case>
  <case name=“C”>an answer choice for option C </case>
  <case name=“D” param=“result” value=“1”
  image=”c:\animagenameforwholequestion.jpg>\
  An answer choice - for the correct option D
  </case>
  <image>C:\images\testidimagename.jpg </image>
  <hint>text to provide a hint for the user if this is allowed for this particular quiz or
test</hint>
  <help>test to provide more detailed help for this </question>
  <results>
  <result param=“result” minvalue=“1” maxvalue=“1”>Result Text for this range.</result>
  <result param=“result” minvalue=“2” maxvalue=“2”>Result Text for midpoint range
result>
  </results>
  </mobizamtest>
```

The XML of the test may be as follows:

| Tag Name | Sub tag | Definition |
|---|---|---|
| Mobizam | | Defines this as a mobizam test or |
| | | test set |
| header | | Defines the test name, and any |
| | | restrictions |
| | <description> | |
| | <testid> | |
| | <testauthority> | |
| | <authoritycontact> | |
| | <hints> | |
| | <help> | |
| | <timelimit> | |
| | <datelimit> | |
| questions | question | |
| | id | The unique id for this question in |
| | | this question set. |
| | select | Is this a multiple or single |
| | | selection question? |
| | title | Title of question |
| | nextid | Next question in sequence for this |
| | | question set. |
| | comment | An optional comment to be |
| | | displayed or read. |
| | case | One case of an answer. The case |
| | | ID is the option that is presented |
| | image | An image or picture for use during |
| | | this question only. |
| | type | Type of question - could be mc |
| | | (multiple choice) or ti (text input) |
| | | or fc (flash card). |
| | Image | A picture gif, jpg, or png file to |
| | | display during this question. |

The XML defining the test in content 58 may be encrypted so that it is non-trivial to extract information directly from the test itself. In addition, to reduce the bandwidth needed to transfer content 58 to controlling device 52, content 58 may be compressed and encrypted. The encryption may use public key PKI encryption.

An integration wrapper may be used to integrate content 58 with industry standards such as SCORM (shareable courseware object reference model) and AICC (aviation industry CBT Committee) and any other e-learning industry standards as may be appropriate.

An embodiment of the invention provides the ability to combine technologies such as Text to Speech, a unique educational XML schema, and other rich content display multi-media technologies for the mobile application space to create a unique educational methodology.

System 50 provides the ability to use the above framework to produce a certificate including release codes based on a student's test performance criteria to control the accessibility or capability of a controlled device. For example, system 50 provides the ability to control what facilities, utilities, or applications that a student may be able to use on their PC, TV or gaming system dependent on their performance on a test taken on either another PC or mobile device (such as a smart phone).

System 50 forwards answers 68 and/or score 64 to a central point such as server 54 and database 62 where the results can be automatically scored, thus saving teachers and parents assessment time. Parents, for example, can determine whether homework has been completed, when the homework has been completed, and how their child performed relative to the rest of the students in their class, peer group, geography or other measurement group through comparative analysis with other students sending data to database 62.

As database 62 can store data relating to tests taken by user 60 as well as tests taken by other users, database 62 can provide a wealth of information about users using system 50. For example, a system in accordance with the invention has the ability to produce integrated heuristic and other analytics based on the performance and style of responses as to a test compared with other behavior, patterns, duration, location, various time intervals, level of help, and responses to post analysis questions. The time intervals may include the time between questions in a test or the time between tests. Such information may indicate a tendency to procrastinate, difficulty with a subject, certain time constraints, poor time management, etc.

For example, post analysis questions, asking the user how he thinks he performed on a test may be included in content 58. The answers to those post analysis questions may be included in answers 68.

An analytical engine 78, in communication with database 62 and server 54, may perform analysis of data in database 62 and produce percentile mapping for user 60 thus allowing either the user, or those monitoring the user, the ability to measure the user's relative performance to a group, sub-set of groups, or superset of groups typically related to the user's peers. This allows for mapping over both a flat dimension of time (for example the current year) or alternatively mapping for a multi-time dimension (for example comparison for same peers at the same percentile points across multiple years). For example, a comparison may be generated of performance for this user with similar users over the last 3 years or curriculum point.

Analytical engine 78 may use analytical seeding to identify learning patterns from those diagnosed with early staged learning difficulties such ADD/H, Autism or Oppositional learning. For example, when user 60 registers, he or a parent may input factors relating to learning difficulties in background information 80. Alternatively, each education content provider may define unique parameters or factors relating to its industry and clients. These parameters may be related to previously diagnosed samples, results or metrics. Analytical engine 78 may compare results to these metrics. Similarly, an individual standard may be defined for a particular user based on prior tests. Any major deviation from such a standard may be flagged for further attention.

Achievable targets will vary among users. Content 58 including question sets may be derived from a common core set of questions, but may be dynamically altered based on a user's performance on tests and the performance of similar users.

The analytical engine 78 understands where students are struggling and why they are struggling and can predict with high accuracy how to overcome the learning difficulty for a given subject. As a standard may be defined for each user, analytical engine 78 will know that a student requires more time to complete a test and may factor in such needed time. Similarly, if the standard for a user to finish a test is X minutes based on prior tests, then if the user takes X+2 minutes, analytical engine 78 may generate an “alert” flag, X+5 minutes may yield a “potential danger” flag, and X+6 minutes a “potential problem” flag. Clearly other types of flags may be used.

Engine 78 can provide additional content to user 60 to assist with learning and explanations, or may suggest a different subject level which may be more difficult or easier than the level the user is currently attempting or may suggest an entirely different subject.

Analytical engine 78 is further able to identify patterns that will place a student within a learning range or pattern. For example, testing authority 66 (e.g. school, teacher, parent) may be advised to test the student more thoroughly for characteristics shown based on the analytics. One application of this may consider that those children with low attention span or ADD or other learning difficulty may answer questions in any particular heuristic manner. For example, children with ADDH (attention deficit disorder/hyperactivity) will show a particular pattern of answering questions and may have a relatively high number of partially completed tests. As discussed above, an individual standard may be defined and then deviations from that standard may be flagged. Similarly, the individual standard may be compared with class and group standards to identify certain learning patterns.

Answers to pre and post test questioning could, for example, determine a child's level of esteem (e.g. students responding consistently that they thought they had performed poorly, when in fact, they had performed above average). Heuristic measurement points include analysis points that are not directly related to a student's main test score results. Test score results are added to the analytical engine, but are also used separately. These heuristic measurements include, but are not restricted to, those below. It should be noted that not all of these metrics will be applicable, appropriate or relevant. However, they may help analytical engine 78 learn about patterns and predictability of performance, create early diagnosis of potential clinical issues, and/or suggest the optimum learning content. For example, an algorithm may identify students in a particular geography scoring statistically particularly low or high. The algorithm may run a correlation of those students against interests/hobbies or other characteristics discussed below. If there is a correlation higher than 30%-50% between a characteristic and a low or high score on a test, a weight may be assigned to the characteristic connecting it to the score.

1. Difference in time between access to a test or question set (either flash cards, or quiz or other test type) and the start time of that test. This measures qualities such as “procrastination” and focus.

2. Choice of which test to start first. Subject preference can indicate aspects about the individual when mapped to other measurement criteria. This is sometimes called comfort zoning.

3. Sex of student.

4. Age of Student.

5. Age of Parents (where relevant).

6. Profession of Student.

7. Hobbies.

8. Marital Status.

9. Number of Children.

10. Favorite T.V. Program.

11. Number of times the student changed schools (where relevant).

12. Age of Children (where relevant).

13. Clubs or Associations of Student.

14. Is the spousal supporting the study and time?

15. Parent's Profession (where relevant).

16. Parents Earnings Range.

17. Geographical Area.

18. Social status including earning level, educational background, profession, etc.

19. Type of Car (where relevant).

20. Number of Computers in House.

21. Physical Health of Student.

22. Highest Academic Achievement.

23. Did student attend pre-school?

24. Where did student attend pre-school (where relevant)?

25. Does the student play computer games?

26. If so which ones?

27. Other physical characteristics (for example those with BMI over a certain level may have certain attributes).

28. Standard Deviation index for similar tests for this student from other results. Here, the analytical engine looks not at cognitive performance per se, but at how wildly a student might deviate between similar tests. This may indicate a number of factors—dependent on other heuristics. For example, if a student performs very well on a first test and then on a retest, or on questions that are subsumed into another test, they perform less well, such a scenario might indicate that the first test was performed with assistance or indicate that the time of day that a test is performed is particularly relevant for this student.

29. Location—a GPS can determine where the test is conducted. This can help the analytic engine understand the most productive environments for this student. Other analysis can be understood from the location of the tests.

30. Number of times that hints are used.

31. Times that help is used.

32. Times that the test is paused.

33. Number of times tests are left uncompleted.

34. Number of times tests are not started.

35. Answers to specific pre/post test questions.

36. Number of tests completed.

37. Time intervals between question responses.

38. Whether a Text to Speech announcement is used or whether silent (manual) input is used.

39. The students perceived “mood” pre and post test questions.

40. Time taken to complete the test.

41. Time taken to review the test.

42. Review time per question.

43. Number of times student has been “tardy” or late to school.

44. Number of school days student missed in last school year due to authorized absence.

45. Number of school days student missed in last school year due to unauthorized absence.

46. What siblings does student have?

47. Where is student placed if there are siblings (e.g. is this the first child, middle child, 4th child, youngest child etc.?)

48. What are the ages and sex of the siblings?

49. How do the siblings interact with each other?

50. What other professional qualifications does the student hold?

51. Have parents experienced any major illnesses or traumas?

52. Has the student experienced any major traumas or illnesses?

53. What is the student's favorite subject?

54. What is the student's favorite game (non-computer)?

55. How many times has the child traveled abroad in the last 12 months?

56. What is student's first language?

57. Where is the student's principal learning establishment located?

58. How did the student's principal learning environment perform relative to other schools/learning establishments in the area?

59. What is the first language of the student's principle learning establishment?

60. Has the student been diagnosed with any learning difficulty?

61. If so, which one?

62. Has the student's parents been diagnosed with any learning difficulty?

63. If so, which one?

64. Has any of the student's siblings been diagnosed with any learning difficulty?

65. If so, which one?

The above is only a subset of questions that may be entered either during pre test or student registration in background 80 or analyzed post test and included in answers 68. Some analysis may occur during the test for real time analysis. The questions illustrated above are not necessarily presented in any particular order.

A set of algorithms may use the above information to identify students likely to perform well, students with learning difficulties, optimum learning locations for specific students, and subjects likely to be most successful or of most interest to a particular student.

As much of the analyzed data may be in the form of unstructured content, a Bayesian, feature set analysis or support vector machine (SVM) may be used to auto convert educational and other content from its original format to another format (such as XML) suitable for further processing.

Once base content has been constructed it can be additionally rated to map onto the analytics such that content can be either be created or converted to map on to different student learning situations.

While preferred embodiments of the invention have been disclosed, obvious variation and improvements may be made without departing from the scope or spirit of the invention. The invention is only limited by the scope of the accompanying claims.

What is claimed is:

1. A method for enabling a feature of a controlled device, the method comprising:
disabling at least one feature of a controlled device;
forwarding a test to a user;
receiving at least one answer to the test from the user;
determining a score based on the answer;
generating a certificate based on the score;
forwarding the certificate to the user; and
enabling the at least one feature of the controlled device based on the certificate.

2. The method as recited in claim 1, wherein the test is forwarded to the user on a mobile device.

3. The method as recited in claim 1, wherein the controlled device is at least one of a telephone, television, video game system, and computer.

4. The method as recited in claim 1, further comprising:
determining a plurality of scores for a plurality of tests for the user;
determining a standard for the user based on the plurality of scores.

5. The method as recited in claim 4, wherein the standard includes a first time duration for the user to take the test and the method further comprises generating a flag when the user takes another test in a second time duration greater than the first time duration.

6. The method as recited in claim 1, further comprising:
storing the score in a database along with other scores from other users; and
generating information about the user based on the score and the other scores.

7. The method as recited in claim 2, wherein the enabling is performed by communicating the certificate through wireless communication between the mobile device and the controlled device.

8. The method as recited in claim 1, wherein the certificate includes a release code.

9. The method as recited in claim 1, wherein the certificate includes an expiration condition.

10. The method as recited in claim 1, wherein the at least one feature of the controlled device is disabled a defined period of time after the enabling.

11. The method as recited in claim 1, further comprising enabling the at least one feature based on a key used by a second distinct user.

12. The method as recited in claim 1, wherein the test is one of a quiz and a flash card.

13. The method as recited in claim 1, further comprising generating another test based on the score.

14. The method as recited in claim 1, wherein the user generated the answer and the method further comprises receiving additional information entered by the user before the user generated the answer.

15. The method as recited in claim 1, wherein the user generated the answer and the method further comprises receiving additional information entered by the user after the user generated the answer.

16. The method as recited in claim 1, further comprising:
receiving additional information about the user;
correlating the score with the additional information; and
assigning a weight to the additional information based on the correlating.

17. A system for enabling a feature of a controlled device, the system comprising:
a first device effective to receive a test, display the test to a user, and to receive at least one answer from the user relating to the test;
a processor in communication with the first device, the processor effective to generate a certificate based on the answer;
wherein the first device is further effective to receive the certificate and communicate the certificate to a controlled device; and
wherein a feature of the controlled device is enabled based on the certificate.

18. The system as recited in claim 17, wherein the controlled device is at least one of telephone, a television, video game system, and computer.

19. The system as recited in claim 17, wherein:
the processor generates a score based on the answers; and
the certificate is generated based on the score.

20. The system as recited in claim 17, wherein the first device is a mobile device.

21. The system as recited in claim 17, further comprising a database effective to store the score along with other scores of other users.

22. The system as recited in claim 17, wherein the first device is effective to communicate the certificate to the controlled device through wireless communication.
